(19) United States
(12) Patent Application Publication
(10) Pub. No.: US 2025/0103850 A1
(43) Pub. Date: Mar. 27, 2025

(54) Custom Layout Recommendation Using Machine Learning

(71) Applicant: Synopsys, Inc., Sunnyvale, CA (US)

(72) Inventors: Shabbir Batterywala, Bangalore (IN); Pradeepkumar Patil, Bangalore (IN); Anoop Nair, Bangalore (IN)

(21) Appl. No.: 18/476,302

(22) Filed: Sep. 27, 2023

(51) Int. Cl. G06N 3/04

(52) U.S. Cl. CPC G06N 3/04

(57) ABSTRACT

A processing device may acquire an input (302), where the input specifies a set of devices to be placed and routed for a circuit design. In response to the input, the processing device may execute a machine learning model (304) to compute a probability distribution function over a library of historical device placements that estimates a suitability of each historical device placement in the library of historical device placements for placing and routing the set of devices specified in the input. The processing device may present (306) graphical representations for a defined number of historical device placements from the library of historical device placements that are estimated to be suited for placing and routing the set of devices based on the probability distribution function.

### TECHNICAL FIELD

The present disclosure relates generally to electronic design automation, and relates more particularly to machine learning-based techniques for recommending custom layouts for analog designs.

### BACKGROUND

Analog designs are composed of well-defined building blocks representing devices such as differential pairs, current mirrors, custom digital cells, amplifiers, and the like. These devices are captured in a schematic design, from which a netlist is extracted and used for simulation in order to ensure that the design meets specifications. A layout for the schematic design is then created in which the devices are placed and routed, and simulations are performed from the post-layout netlist with parasitic effects. The placement and routing of devices in the layout may be refined until the post-layout simulations meet the specifications for the design.

### SUMMARY

In one example, a processing device may acquire an input, where the input specifies a set of devices to be placed and routed for a circuit design. In response to the input, the processing device may execute a machine learning model to compute a probability distribution function over a library of historical device placements that estimates a suitability of each historical device placement in the library of historical device placements for placing and routing the set of devices specified in the input. The processing device may present graphical representations for a defined number of historical device placements from the library of historical device placements that are estimated to be suited for placing and routing the set of devices based on the probability distribution function.

In another example, a system may include a memory storing instructions and a processing device coupled with the memory and to execute the instructions. When executed, the instructions cause the processing device to build a library of historical device placements, where each data point in the library comprises a set of devices for a circuit design and an historical device placement that was generated for the set of devices. The instructions may further cause the processing device to train a machine learning model, using the library of historical device placements, to compute a probability distribution function over the library of historical device placements that estimates a suitability of each historical device placement in the library of historical device placements for placing and routing a set of devices for a new circuit design.

In another example, a non-transitory computer readable medium may include stored instructions. When executed by a processing device, the stored instructions may cause the processing device to acquire an input, where the input specifies a set of devices to be placed and routed for a circuit design. In response to the input, the processing system may execute a machine learning model to compute as an output a probability distribution function over a library of historical device placements that estimates a suitability of each historical device placement in the library of historical device placements for placing and routing the set of devices specified in the input. The processing system may then present, via a graphical user interface, graphical representations for a predefined number of historical device placements from the library of historical device placements that are estimated to be best suited for placing and routing the set of devices based on the probability distribution function.

### BRIEF DESCRIPTION OF THE DRAWINGS

The present disclosure will be understood more fully from the detailed description given below and from the accompanying figures of embodiments of the present disclosure. The figures are used to provide knowledge and understanding of embodiments of the present disclosure and do not limit the scope of the present disclosure to these specific embodiments. Furthermore, the figures are not necessarily drawn to scale.

FIG. 1 illustrates an example method for training a machine learning model to recommend custom layouts for analog designs according to the present disclosure.

FIG. 2 illustrates an example sequential neural network that has been trained to receive as an input a set of devices to be placed and routed for a custom design and to compute as an output a probability distribution function over a library of historical device placements that estimates a suitability of each historical device placement in the library of historical device placements for placing and routing the input set of devices according to the present disclosure.

FIG. 3 illustrates an example method for recommending a historical device placement for placing and routing of a set of devices of a new custom design using machine learning.

FIG. 4 illustrates a flowchart of various processes used during the design and manufacture of an integrated circuit in accordance with some embodiments of the present disclosure.

FIG. 5 illustrates a diagram of an example computer system in which embodiments of the present disclosure may operate.

### DETAILED DESCRIPTION

Aspects of the present disclosure relate to machine learning-based techniques for recommending custom layouts for analog designs. As discussed above, analog designs are composed of well-defined building blocks representing devices such as differential pairs, current mirrors, custom digital cells, amplifiers, and the like. These devices are captured in a schematic design, from which a netlist is extracted and used for simulation in order to ensure that the design meets specifications. A layout for the schematic design is then created in which the devices are placed and routed, and simulations are performed from the post-layout netlist with parasitic effects. The placement and routing of devices in the layout may be refined until the post-layout simulations meet the specifications for the design. Although tools exist to assist engineers in layout creation, the process still involves a great deal of manual effort, and, thus, can be very time consuming.

Examples of the present disclosure train a machine learning model to recommend a layout from a library (repository) of historical (i.e., previously created) layouts when provided with a set of devices for a new custom design. In one example, training data in the form of historical layouts is collected automatically when new placement pieces are committed to main layouts that are under development as well as from placement projects that have already been completed. A machine learning model, such as a sequential neural network (SNN), may then be trained on the training data to learn correspondences between devices in schematics and the placements of those devices in layouts. Thus, when an input comprising a set of devices to be placed and routed is provided to the trained machine learning model, the trained machine learning model may identify a number of historical layouts from the library that are best suited for the input set of devices (e.g., to be reused to place and route the input set of devices).

In one example, the historical layouts that are recommended by the machine learning model may be presented to a user in the form of snapshots, which are graphical representations of the corresponding historical layouts. The user may load a recommended historical layout into the main symbolic canvas of a symbolic editor tool by simply selecting (e.g., double clicking on) the recommended historical layout's snapshot. Alternatively, the user may elect not to load any of the recommended historical layouts and may instead manually create a new layout (which may be collected as a “new” historical layout and used to further train the machine learning model).

Technical advantages of the present disclosure include, but are not limited to, the ability to quickly place and route devices in a custom design. In particular, by training a machine learning model to capture collective knowledge and layout practices followed in previous custom layouts, the amount of time, computing resources, and manual effort needed to construct a layout to specifications for a new custom layout can be greatly reduced. Moreover, experimental results have shown that in a majority of test cases, the disclosed approach can recommend device placements with eighty percent or better device and netlist match.

As used within the context of the present disclosure, the term “custom design” is understood to refer to a schematic of an analog device (or a portion of an analog device), from which a netlist may be extracted. A “custom design” may be considered more broadly as an instance of a circuit design that is, historically, developed at least in part via manual effort rather than by fully automated electronic design automation tools. The term “custom layout” is understood to refer to the placement and routing of the devices (e.g., differential pairs, current mirrors, custom digital cells, amplifiers, and the like) that are contained in the custom design.

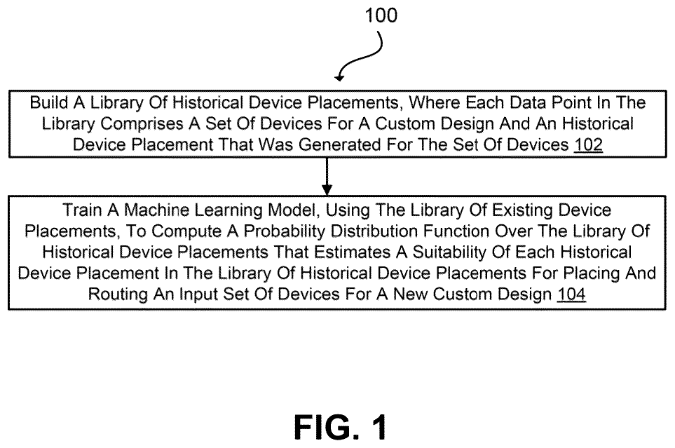

FIG. 1 illustrates an example method 100 for training a machine learning model to recommend custom layouts for analog designs according to the present disclosure. In one example, the method 100 may be implemented as an optional function in a symbolic editor or other analog layout tools used to create custom layouts. In another example, the method 100 may be implemented as a separate or standalone function that may interact with a symbolic editor or other analog layout tools.

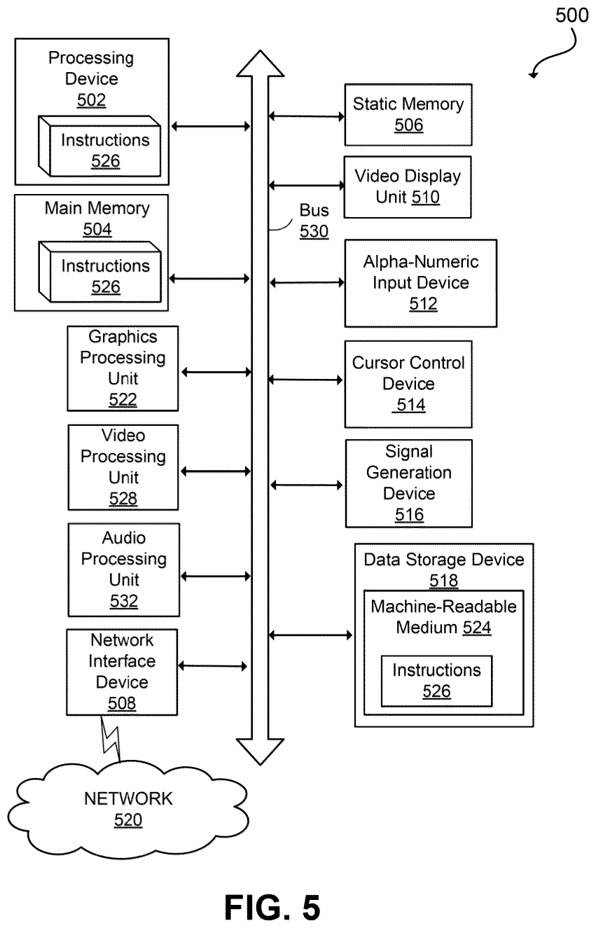

In one example, the method 100 may be performed by a computer system, such as the computer system 500 of FIG. 5. In another example, the method 100 may be performed by a processing device, where the processing device may comprise a component of a computer system such as the computer system 500 of FIG. 5 (e.g., processing device 502). For the sake of example, the method 100 is described below as being performed by a processing device.

The method 100 begins in step 102. In step 102, the processing device may build a library of historical device placements, where each data point in the library comprises a set of devices for a custom design and an historical device placement that was generated for the set of devices.

Within the context of the present disclosure, an “historical” device placement is understood to refer to a placement for a set of devices that has already been committed, as opposed to, for example, a device placement that has yet to be generated. For instance, an historical device placement may be collected automatically and written to user-specified repository when a user commits a placement piece into a main layout for a custom design that is under development. In one example, the historical device placement may be collected as a YAML ain't markup language (YAML) file. In a further example, the YAML file may include auxiliary data relating to the historical device placement, such as a symbolic layout snapshot, library information, project information, user information, or the like. As discussed in further detail below, this auxiliary data may be used to filter the output of the machine learning model.

An historical device placement may also be collected from a design library, which may contain schematic and layout designs for different cells of completed custom design projects. In one example, the design library may store the schematic and layout designs as graphic design system (GDS) II files. By running layout versus schematic (LVS) tools on the GDSII files, a correspondence can be established across devices in a schematic and the placements of those devices in a corresponding layout. A set of devices and an historical device placement for the set of devices can then be extracted from the GDSII files using this correspondence.

As discussed above, each data point in the library built in step 102 may comprise a set of devices for a custom design and an historical device placement that has been generated for the set of devices. In one example, the set of devices may be obtained from a netlist for a custom design. Thus, the set of devices may comprise a plurality of devices to be placed. In one example, each device in the set of devices may be represented by a tuple of numbers, where each number in the tuple of numbers represents a value for one attribute of the device. An attribute for a device may comprise, for instance, a type of the device such as p-type metal oxide semiconductor (PMOS) or n-type metal oxide semiconductor (NMOS), a total channel width of the device, a channel length of the device, a number of fingers in the device, a multiplier for the device, a number of vector bits (when the device is a vector-device), or the like. Each device may be further represented by a numeric identifier associated with a connectivity graph that represents the connectivity of the device. For instance, a numeric identifier may uniquely identify a particular unique (non-isomorphic) connectivity graph. In one example, the set of devices may be represented by a single vector comprising a concatenation of the attribute tuples and numeric connectivity graph identifiers for all of the devices in the set of devices.

In one example, an historical device placement corresponding to a set of devices for a custom layout may be represented by an identifier that uniquely identifies the multi-row left-to-right relative placement of the set of devices. Thus, each data point collected in step 102 may comprise: (1) a vector comprising a concatenation of the attribute tuples and numeric connectivity graph identifiers for a set of devices for one custom design; and (2) the identifier associated with the historical placement of the set of devices represented in the vector.

It should be noted that for some sets of devices in the data points that are collected, multiple historical device placements may be identified as being suitable for placing and routing the same set of devices, with no way to determine which of the multiple historical device placements is “best.” For instance, multiple distinct placements may exist for same set of input devices, where the multiple placements differ from each other due to the presence of different types and/or numbers of dummy devices (i.e., devices that are not part of the set of input devices) that have been included in the placements for electrical protection purposes. Depending on the amount of electrical protection required, different numbers of dummy devices in different locations may be included. In other cases, multiple distinct placements may exist for same set of input devices because the multiple placements may have different aspect ratios. In the case where multiple distinct placements exist for a given set of devices, the processing device may create an equivalence class containing all of the historical device placements that are determined to be suitable for routing and placing the same set of devices. An identifier may be assigned to the equivalence class and used in a data point in place of an identifier associated with a single historical placement. Where the historical device placements in an equivalence class have different aspect ratios, the processing device may help a user to identify the aspect ratio that is best suited for a given set of devices based on the context of the overall layout.

Building of the library in accordance with step 102 may be an ongoing process. That is, the library may be continuously augmented with new data points as access to new design libraries is obtained or as users commit new placement pieces into main layouts for custom designs that are under development. In one example, a user who is designing a layout may enable automatic collection of new placement pieces that they commit prior to committing the new placement pieces. For instance, a feature to enable automatic collection of new placement pieces may be enabled by the user upon startup of a layout design tool. In this way, any new placement pieces that are committed may be collected automatically, without interrupting the user's workflow. Additionally, users who do not wish for their placement pieces to be collected as training data may disable the feature that enables collection of new placement pieces.

In step 104, the processing device may train a machine learning model, using the library of historical device placements, to compute a probability distribution function over the library of historical device placements that estimates a suitability of each historical device placement in the library of historical device placements for placing and routing a set of devices for a new custom design.

In one example, the machine learning model may comprise a neural network model. For instance, in one example, the machine learning model may comprise a sequential neural network (SNN). The SNN may be trained as a classification model which returns a best matching historical device placement (or a predefined number of best matching historical device placements) from the library of historical device placements for a new set of devices to be placed and routed, based on the results of the probability distribution function. In other examples, the machine learning model may comprise another type of machine learning model, such as a regression model, a decision tree, a support vector machine, a random forest model, or a neural network model having an architecture that is different from an SNN (e.g., a convolutional neural network).

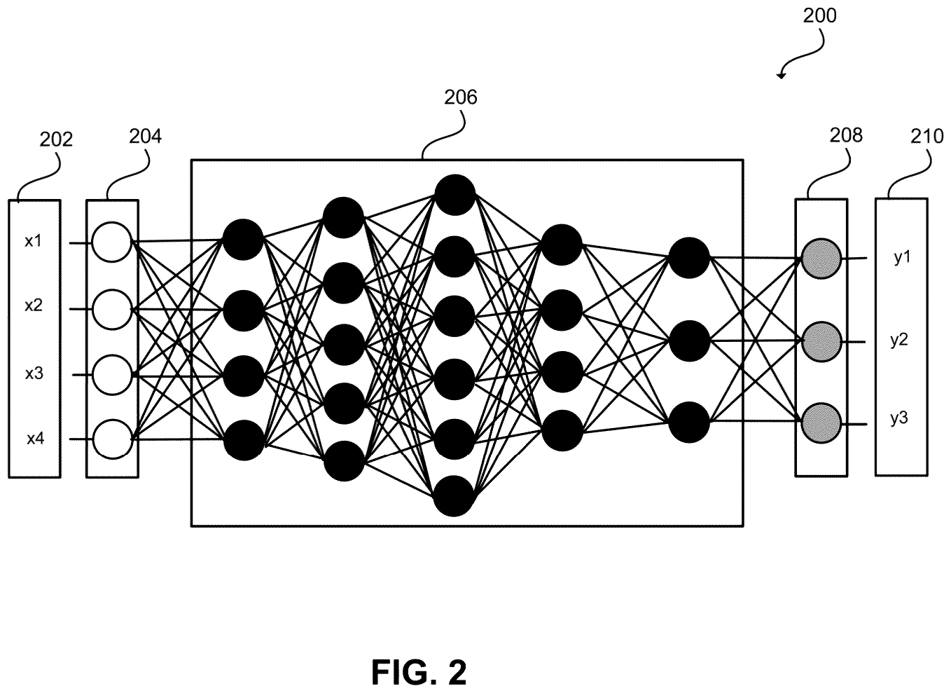

FIG. 2 illustrates an example sequential neural network (SNN) 200 that has been trained to receive as an input a set of devices to be placed and routed for a custom design and to compute as an output a probability distribution function over a library of historical device placements that estimates a suitability of each historical device placement in the library of historical device placements for placing and routing the input set of devices according to the present disclosure.

In one example, the SNN 200 comprises a plurality of layers, including an input layer 204, an output layer 208, and a plurality of hidden layers 206 positioned between the input layer 204 and the output layer 208. Each of the input layer 204, the output layer 208, and the plurality of hidden layers 206 comprises a plurality of nodes.

In one example, the number of nodes contained in the input layer 204 represents the largest size of the input values 202 (i.e., device vectors x1-x4) to be supported by the SNN 200. Although the input layer 204 of FIG. 2 is illustrated as containing four nodes, it will be appreciated that the input layer 204 may contain any number of nodes depending on the size of the input vector to be supported.

In one example, the number of nodes contained in the output layer 208 represents the number of unique output values 210 (i.e., historical device placements y1-y3) contained in the data used to train the SNN (i.e., the library of historical device placements built in step 102 of FIG. 1). Although the output layer 208 of FIG. 2 is illustrated as containing three nodes, it will be appreciated that the output layer 208 may contain any number of nodes depending on the number of data points contained in the training data. Moreover, since the quality of the SNN's output is only as good as its training data, new data points may be continuously added to the library of historical device placements to improve the quality of the SNN output. As such, the number of nodes contained in the output layer 208 may increase as the number of data points in the library of historical device placements increases.

In one example, the hidden layers 206 may comprise a plurality of layers, where each layer of the plurality of layers contains a plurality of nodes. Although the hidden layers 206 of FIG. 2 are illustrated as comprising five layers containing varying numbers of nodes, it will be appreciated the hidden layers 206 may comprise any number of layers containing any number of nodes. In one example, the SNN 200 includes three or four hidden layers depending upon the dimensions of the input (device) vectors and the size of the training data (i.e., number of data points in the library of historical device placements).

In one example, open-source, general-purpose programming language application programming interfaces (APIs) may be used to train the SNN 200 and for using the SNN 200 to generate recommended device placements.

An advantage of training the machine learning model in the manner described above is that the training allows the machine learning model to capture collective knowledge and layout practices followed in previous custom layouts. Moreover, historical device placements recommended by the machine learning model are ready to consume in placement and routing implementations. This reduces the amount of time, resources, and manual effort needed to construct a layout to specifications for a new custom design.

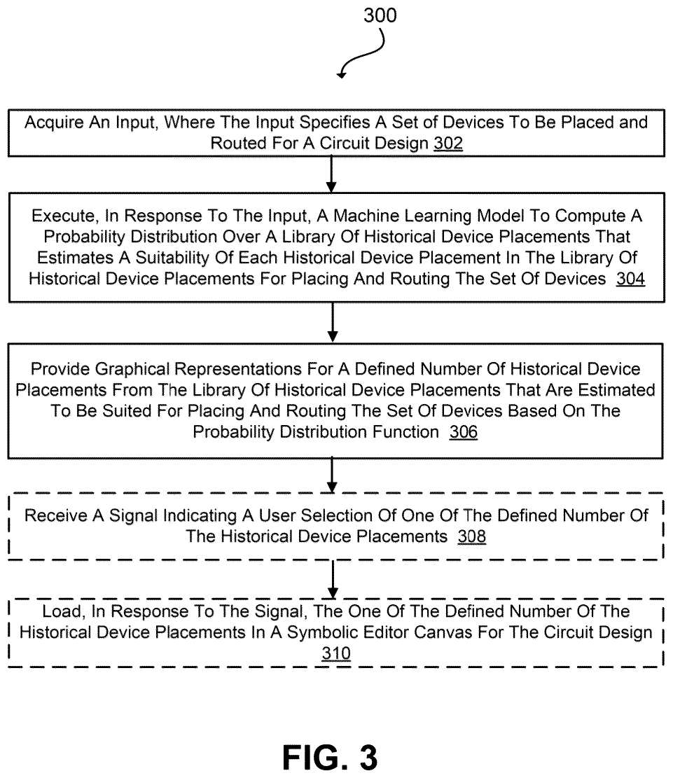

FIG. 3 illustrates an example method 300 for recommending a historical device placement for placing and routing of a set of devices of a new custom design using machine learning. In one example, the method 300 may be implemented as an optional function in a symbolic editor or other analog layout tools used to create custom layouts. In another example, the method 300 may be implemented as a separate or standalone function that may interact with a symbolic editor or other analog layout tools. For instance, the method 300 may be loaded in a separate utility (or executable) that can function as a placement recommendation service available to multiple users interacting with the utility.

In one example, the method 300 may be performed by a computer system, such as the computer system 500 of FIG. 5. In another example, the method 300 may be performed by a processing device, where the processing device may comprise a component of a computer system such as the computer system 500 of FIG. 5 (e.g., processing device 502). For the sake of example, the method 300 is described below as being performed by a processing device.

In step 302, the processing device may acquire an input, where the input specifies a set of devices to be placed and routed for a circuit design (e.g., a new custom design).

As discussed above, in one example, the input may comprise a vector. The vector may comprise a concatenation of attribute tuples and numeric connectivity graph identifiers for all of the devices in the set of devices. Each number in an attribute tuple represents a value for one attribute of a device to which the attribute tuple corresponds. An attribute for a device may comprise, for instance, a type of the device such PMOS or NMOS, a total channel width of the device, a channel length of the device, a number of fingers in the device, a multiplier for the device, a number of vector bits (when the device is a vector-device), or the like. Each numeric connectivity graph identifier may uniquely identify a particular unique (non-isomorphic) connectivity graph that represents the connectivity of a device to which the numeric connectivity graph identifier corresponds.

In one example, the set of devices may be obtained from a netlist for a new circuit design (e.g., a custom design whose device placement has yet to be committed or finalized). The set of devices may be acquired from the netlist in response to a signal received from a user which indicates that an input vector should be constructed from the set of devices. In another example, the user may enable a feature which causes the processing device to automatically construct an input vector for a set of devices whenever a layout tool is started on a set of devices with no current placement or routing.

In a further example, the input may additionally comprise one or more user-specified filters to be applied when recommending historical device placements for placing and routing the set of devices specified in the input. For instance, a library of historical device placements may contain historical device placements for a plurality of different process nodes (e.g., 10 nm, 5 nm, 3 nm, or the like), but a user may only wish to see recommendations from one (or fewer than all) of these process nodes.

In step 304, the processing device may execute, in response to the input, a machine learning model to compute (e.g., as an output of the machine learning model) a probability distribution function over a library of historical device placements that estimates a suitability of each historical device placement in the library of historical device placements for placing and routing the set of devices specified in the input.

In one example, the machine learning model may comprise a neural network (e.g., an SNN) that has been trained to take as an input a set of devices to be placed and routed for a new circuit design and to compute as an output a probability distribution function over a library of historical device placements to estimate the suitability of each historical device placement in the library of historical device placements for placing and routing the input set of devices. In one example, the machine learning model may comprise a machine learning model that is similar to the SNN illustrated in FIG. 2 and described above. However, in other examples, the machine learning model may comprise another type of machine learning model, such as a regression model, a decision tree, a support vector machine, a random forest model, or a neural network model having an architecture that is different from an SNN (e.g., a convolutional neural network).

As discussed above, the historical device placements may comprise device placements corresponding to circuit designs (e.g., custom designs) whose device placements have been committed or finalized in the past (e.g., at a time prior to the input being acquired in step 302). These historical device placements may be stored in the library of historical device placements, and the library of historical device placements may be accessible by the machine learning model. The library of historical device placements may also be continuously augmented as access to new design libraries is obtained or as users commit new placement pieces into main layouts for circuit designs (e.g., custom designs) that are under development.

In one example, the processing device may omit or remove from the probability distribution function computation any historical device placements in the library of historical device placements that a user has indicated (e.g., by selecting a filter with the input) should not be applied. For instance, the user may have indicated that historical device placements for certain process nodes should not be considered. In another example, the processing system may apply the filter after the machine learning model has computed the probability distribution function, but before presenting any results of the computation to a user (e.g., as discussed in further detail in connection with step 306).

In step 306, the processing device may provide (e.g., via a graphical user interface) graphical representations for a defined number of historical device placements from the library of historical device placements that are estimated to be suited for placing and routing the set of devices based on the probability distribution function.

In one example, the historical device placement corresponding to the index position where the probability distribution function value is highest may be identified as the historical device placement that is best suited for placing and routing the set of devices. In a further example, the processing device may identify a predefined number of historical device placements having the highest probability distribution function values. For instance, if the predefined number is n, then the processing device will identify the n historical device placements having the highest probability distribution function values as the defined number of historical device placements from the library of historical device placements that are estimated to be suited for placing and routing the set of devices in step 306. In one example, the defined number may be configurable by a user (e.g., an engineer who is designing a layout including the set of devices).

In one example, a graphical representation of an historical device placement may comprise an image “snapshot” of the historical device placement. The snapshot may not comprise an exact duplicate image of the historical device placement, however. For instance, certain information in the historical device placement, such as information that has been designated as proprietary, may be omitted or replaced to prevent inadvertent disclosure of the proprietary information.

In one example, one or more suitability metrics may be displayed alongside each graphical representation. In one example, the one or more suitability metrics include at least one of: a device match metric and a netlist match metric. Each of the device match metric and the netlist match metric may be expressed as a percentage. For instance, if a device match metric for an historical device placement is one hundred percent, this means that all of the devices in the set of devices specified in the input have been matched with devices in the historical device placement; if any devices in the set of devices specified in the input have not been matched to devices in the historical device placement, or if the historical device placement includes devices that are not matched to any devices in the set of devices specified in the input, then the value of the device match metric may be proportionally reduced.

If a netlist match metric for an historical device placement is one hundred percent, this means that the graph of the netlist corresponding to the set of devices specified in the input perfectly matches the graph of the netlist corresponding to the historical device placement. In one example, a graph edit distance may be computed between the graph of the netlist corresponding to the set of devices specified in the input and the graph of the netlist corresponding to the historical device placement, and the graph edit distance may be expressed as the percentage.

It should be noted that in some cases, the processing device may be unable to identify any historical device placements to recommend for the set of devices that is specified in the input. In this case, no graphical representations may be presented. Instead, the processing device may present a message indicating that no historical device placements are recommended.

In optional step 308 (illustrated in phantom), the processing device may receive a signal indicating a user selection of one of the defined number of historical device placements.

For instance, in one example, the user may double click on the graphical representation corresponding to the one of the defined number of historical device placements in order to indicate the user selection. However, in other examples, the user selection may be indicated in other ways, such as other gestures (e.g., single click, drag and drop, tapping on a touch screen, or the like), verbal commands (e.g., speaking an identifier associated with the one of the defined number of historical device placements), typed commands (e.g., typing an identifier associated with the one of the defined number of historical device placements into a field of a dialog), or the like.

In optional step 310 (illustrated in phantom), the processing device may load, in response to the signal, the one of the defined number of historical device placements in a symbolic editor canvas for the circuit design (i.e., the new custom design).

The method 300 may be implemented to recommend and reuse historical device placements for both standard analog cells and for custom analog structures, as well as for different classes of circuits and across different process nodes. For instance, the machine model could be trained specifically to recommend device placements for differential pairs of different drive strengths and protection levels, for current mirrors having different numbers of legs and different ratios, or the like. Filters allow users to customize the recommendations in a user-friendly manner.

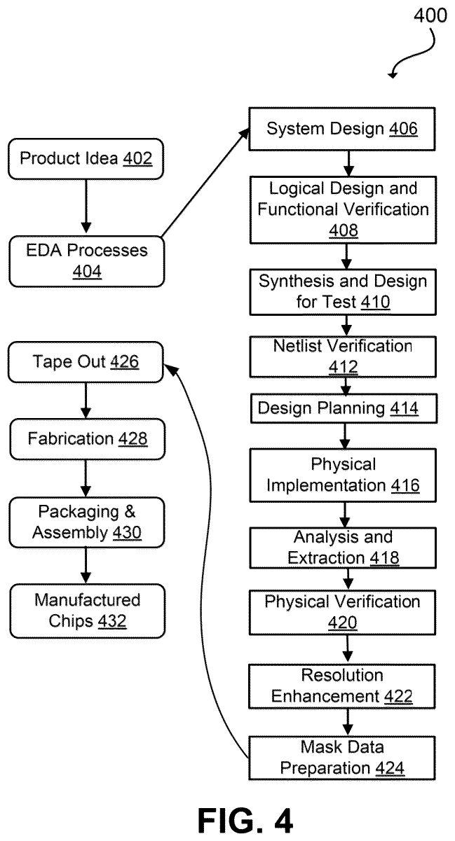

FIG. 4 illustrates an example set of processes 400 used during the design, verification, and fabrication of an article of manufacture such as an integrated circuit to transform and verify design data and instructions that represent the integrated circuit. Each of these processes can be structured and enabled as multiple modules or operations. The term ‘EDA’ signifies the term ‘Electronic Design Automation.’ These processes start with the creation of a product idea 402 with information supplied by a designer, information which is transformed to create an article of manufacture that uses a set of EDA processes 404. When the design is finalized, the design is taped-out 426, which is when artwork (e.g., geometric patterns) for the integrated circuit is sent to a fabrication facility to manufacture the mask set, which is then used to manufacture the integrated circuit. After tape-out, a semiconductor die is fabricated 428 and packaging and assembly processes 430 are performed to produce the finished integrated circuit 432.

Specifications for a circuit or electronic structure may range from low-level transistor material layouts to high-level description languages. A high-level of representation may be used to design circuits and systems, using a hardware description language (‘HDL’) such as VHDL, Verilog, SystemVerilog, SystemC, MyHDL or OpenVera. The HDL description can be transformed to a logic-level register transfer level (‘RTL’) description, a gate-level description, a layout-level description, or a mask-level description. Each lower representation level that is a more detailed description adds more useful detail into the design description, for example, more details for the modules that include the description. The lower levels of representation that are more detailed descriptions can be generated by a computer, derived from a design library, or created by another design automation process. An example of a specification language at a lower level of representation language for specifying more detailed descriptions is SPICE, which is used for detailed descriptions of circuits with many analog components. Descriptions at each level of representation are enabled for use by the corresponding systems of that layer (e.g., a formal verification system). A design process may use a sequence depicted in FIG. 4. The processes described may be enabled by EDA products (or EDA systems).

During system design 406, functionality of an integrated circuit to be manufactured is specified. The design may be optimized for desired characteristics such as power consumption, performance, area (physical and/or lines of code), and reduction of costs, etc. Partitioning of the design into different types of modules or components can occur at this stage.

During logic design and functional verification 408, modules or components in the circuit are specified in one or more description languages and the specification is checked for functional accuracy. For example, the components of the circuit may be verified to generate outputs that match the requirements of the specification of the circuit or system being designed. Functional verification may use simulators and other programs such as testbench generators, static HDL checkers, and formal verifiers. In some embodiments, special systems of components referred to as ‘emulators’ or ‘prototyping systems’ are used to speed up the functional verification.

During synthesis and design for test 410, HDL code is transformed to a netlist. In some embodiments, a netlist may be a graph structure where edges of the graph structure represent components of a circuit and where the nodes of the graph structure represent how the components are interconnected. Both the HDL code and the netlist are hierarchical articles of manufacture that can be used by an EDA product to verify that the integrated circuit, when manufactured, performs according to the specified design. The netlist can be optimized for a target semiconductor manufacturing technology. Additionally, the finished integrated circuit may be tested to verify that the integrated circuit satisfies the requirements of the specification.

During netlist verification 412, the netlist is checked for compliance with timing constraints and for correspondence with the HDL code. During design planning 414, an overall floor plan for the integrated circuit is constructed and analyzed for timing and top-level routing.

During layout or physical implementation 416, physical placement (positioning of circuit components such as transistors or capacitors) and routing (connection of the circuit components by multiple conductors) occurs, and the selection of cells from a library to enable specific logic functions can be performed. As used herein, the term ‘cell’ may specify a set of transistors, other components, and interconnections that provides a Boolean logic function (e.g., AND, OR, NOT, XOR) or a storage function (such as a flipflop or latch). As used herein, a circuit ‘block’ may refer to two or more cells. Both a cell and a circuit block can be referred to as a module or component and are enabled as both physical structures and in simulations. Parameters are specified for selected cells (based on ‘standard cells’) such as size and made accessible in a database for use by EDA products.

During analysis and extraction 418, the circuit function is verified at the layout level, which permits refinement of the layout design. During physical verification 420, the layout design is checked to ensure that manufacturing constraints are correct, such as DRC constraints, electrical constraints, lithographic constraints, and that circuitry function matches the HDL design specification. During resolution enhancement 422, the geometry of the layout is transformed to improve how the circuit design is manufactured.

During tape-out, data is created to be used (after lithographic enhancements are applied if appropriate) for production of lithography masks. During mask data preparation 424, the ‘tape-out’ data is used to produce lithography masks that are used to produce finished integrated circuits.

A storage subsystem of a computer system (such as computer system 500 of FIG. 5) may be used to store the programs and data structures that are used by some or all of the EDA products described herein, and products used for development of cells for the library and for physical and logical design that use the library.

FIG. 5 illustrates an example machine of a computer system 500 within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM), a static memory 506 (e.g., flash memory, static random access memory (SRAM), etc.), and a data storage device 518, which communicate with each other via a bus 530.

Processing device 502 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 may also be one or more special-purpose processing devices such as an application specific integrated circuit (ASIC), a field programmable gate array (FPGA), a digital signal processor (DSP), network processor, or the like. The processing device 502 may be configured to execute instructions 526 for performing the operations and steps described herein.

The computer system 500 may further include a network interface device 508 to communicate over the network 520. The computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), a graphics processing unit 522, a signal generation device 516 (e.g., a speaker), graphics processing unit 522, video processing unit 528, and audio processing unit 532.

The data storage device 518 may include a machine-readable storage medium 524 (also known as a non-transitory computer-readable medium) on which is stored one or more sets of instructions 526 or software embodying any one or more of the methodologies or functions described herein. The instructions 526 may also reside, completely or at least partially, within the main memory 504 and/or within the processing device 502 during execution thereof by the computer system 500, the main memory 504 and the processing device 502 also constituting machine-readable storage media.

In some implementations, the instructions 526 include instructions to implement functionality corresponding to the present disclosure. While the machine-readable storage medium 524 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine and the processing device 502 to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense.

What is claimed is:

1. A method comprising:
acquiring, by a processing device, an input, where the input specifies a set of devices to be placed and routed for a circuit design;
executing, by the processing device and in response to the input, a machine learning model to compute a probability distribution function over a library of historical device placements that estimates a suitability of each historical device placement in the library of historical device placements for placing and routing the set of devices specified in the input; and
providing, by the processing device, graphical representations for a defined number of historical device placements from the library of historical device placements that are estimated to be suited for placing and routing the set of devices based on the probability distribution function.

2. The method of claim 1, where the input comprises a vector, and the vector concatenates, for each device in the set of devices to be placed and routed: a tuple of numbers representing values of attributes of the each device and a numeric identifier of a unique connectivity graph that represents a connectivity of the each device.

3. The method of claim 2, wherein the attributes comprise at least one of: whether the each device is an n-type metal oxide semiconductor device or a p-type metal oxide semiconductor device, a total channel width of the each device, a channel length of the each device, a number of fingers in the each device, a multiplier for the each device, or a number of vector bits in the each device.

4. The method of claim 2, wherein the vector is automatically constructed by the processing device when the processing device detects that a layout tool has been started on the set of devices and that the set of devices has not yet been placed or routed.

5. The method of claim 1, wherein the machine learning model comprises a sequential neural network that has been trained on a plurality of data points, and wherein each of the data points represents an historical device placement from the library of historical device placements and an historical set of devices corresponding the historical device placement from the library of historical device placements.

6. The method of claim 1, wherein each historical device placement in the library of historical device placements comprises a device placement corresponding to a circuit design whose device placement was committed at a time prior to the acquiring.

7. The method of claim 1, wherein the defined number is configurable by a user.

8. The method of claim 1, wherein the providing further comprising providing, for each historical device placement of the defined number of historical device placements, at least one of: a device match metric or a netlist match metric.

9. The method of claim 8, wherein the device match metric comprises a percentage that indicates a degree of match between devices in the set of devices specified in the input and devices in the each historical device placement of the defined number of historical device placements.

10. The method of claim 8, wherein the netlist match metric comprises a percentage that indicates a degree of match between a graph of a netlist corresponding to the set of devices specified in the input and a graph of a netlist corresponding to the each historical device placement of the defined number of historical device placements.

11. The method of claim 1, further comprising:
receiving, by the processing device, a signal indicating a user selection of one of the defined number of historical device placements; and
loading, by the processing device in response to the signal, the one of the defined number of historical device placements in a symbolic editor canvas for the circuit design.

12. The method of claim 1, wherein the executing comprises filtering the library of historical device placements to remove from consideration by the machine learning model any historical device placements in the library of historical device placements that a user has indicated should not be considered.

13. A system comprising:
a memory storing instructions; and
a processing device coupled with the memory and to execute the instructions, the instructions when executed cause the processing device to:
build a library of historical device placements, where each data point in the library comprises a set of devices for a circuit design and an historical device placement that was generated for the set of devices; and
train a machine learning model, using the library of historical device placements, to compute a probability distribution function over the library of historical device placements that estimates a suitability of each historical device placement in the library of historical device placements for placing and routing a set of devices for a new circuit design.

14. The system of claim 13, where at least one data point in the library is automatically collected in response to the processing device detecting that a user of an analog design tool has committed new placement pieces into a main layout for circuit design that is under development.

15. The system of claim 13, wherein the machine learning model comprises a sequential neural network model.

16. A non-transitory computer readable medium comprising stored instructions, which when executed by a processing device, cause the processing device to:
acquire an input, where the input specifies a set of devices to be placed and routed for a circuit design;
execute, in response to the input, a machine learning model to compute a probability distribution function over a library of historical device placements that estimates a suitability of each historical device placement in the library of historical device placements for placing and routing the set of devices specified in the input; and
provide graphical representations for a defined number of historical device placements from the library of historical device placements that are estimated to be suited for placing and routing the set of devices based on the probability distribution function.

17. The non-transitory computer readable medium of claim 16, wherein the instructions further cause the processing device to filter the library of historical device placements to remove from consideration by the machine learning model any historical device placements that a user has indicated should not be considered.

18. The non-transitory computer readable medium of claim 16, wherein the machine learning model comprises a sequential neural network that has been trained on a plurality of data points, and wherein each of the plurality of data points represents an historical device placement from the library of historical device placements and an historical set of devices corresponding to the historical device placement from the library of historical device placements.

19. The non-transitory computer readable medium of claim 16, wherein the instructions further cause the processing device to:
receive a signal indicating a user selection of one of the defined number of historical device placements; and
load, in response to the signal, the one of the defined number of historical device placements in a symbolic editor canvas for the circuit design.

20. The non-transitory computer readable medium of claim 16, wherein each historical device placement in the library of historical device placements comprises a device placement corresponding to a circuit design whose device placement was committed at a time prior to the input being acquired by the processing device.
